(19) United States
(12) Patent Application Publication
(10) Pub. No.: US 2009/0080303 A1
(43) Pub. Date: Mar. 26, 2009

(54) Storage Media Housing Device

(76) Inventor: Yoshitaka Nakamura, Tokyo (JP)

Correspondence Address: BIRCH STEWART KOLASCH & BIRCH, PO BOX 747, FALLS CHURCH, VA, 22040-0747, US

(21) Appl. No.: 11/918,013

(22) PCT Filed: Mar. 2, 2006
(86) PCT No.: PCT/JP2006/304001

§ 371 Date: Oct. 5, 2007

(30) Foreign Application Priority Data
May 9, 2005 (JP) 2005-135880

(51) Int. Cl. G11B 27/36

(52) U.S. Cl. 369/53.1; G9B/27.052

(57) ABSTRACT

A storage media housing device includes a housing means (1) for housing storage media; a position detecting section (2) detecting a position of the housing means (1); a transfer means (3) for transferring the housing means (1) to a desired position on command; a control means (4) for outputting a transfer control signal to the transfer means (3) so as to transfer the housing means (1) to the desired position; a compare means (5) for comparing the desired position of the housing means (1) based on the transfer control signal controlled by the control means (4) and the detected position of the housing means (1) detected by a position detecting means (6); and the position changing means (6) for changing the transfer control signal of the control means (4) based on the compared result of the compare means (5) and for changing the transfer position of the housing means (1).

### TECHNICAL FIELD

The present invention relates to a storage media housing device housing a plurality of storage media, particularly optical disks.

### BACKGROUND ART

In conventional devices that house a plurality of media and exchange and reproduce a medium, a device having functions of moving a medium by elevating it; selecting and reproducing any media; or ejecting a medium therefrom, has been put to practical use.

Further, in recent years, a plurality of media exchanging and reproducing device, which houses a plurality of media in one media-reproducing device, and automatically selects and reproduces those, has been widespread for enhancing convenience of a user in a vehicle.

Especially, a plurality of in-dash based media exchanging and reproducing device attachable to a dashboard, has been pervading because its convenience allowing a user to exchange a medium with the user sitting on a seat is compatible with its expediency permitting long time continuous reproduction.

Patent Document 1: JP-A7-061523

In the conventional device, its elevating mechanism executing a going up and down movement to receive a disk to a fixed position gives rise to a difference between a target position and an actual damping position. In other words, it is difficult for a medium to stop within the target range of the stoppage thereof.

Further, a medium exchanging operation takes much time or the operation ends in failure owing to inability of the stoppage of the medium within the target range of the stoppage thereof.

The present invention has been made to solve the above-mentioned problems, and an object of the present invention is to provide a storage media housing device able to smoothly perform a transfer operation of a storage medium by feeding back an overrun, which is a difference from the target position occurred during transfer of the storage medium to the target position, to a damping position of the next time transfer of the storage medium to the target position, and by stopping the storage medium at the target position.

Moreover, an object of the present invention is to provide a storage media housing device capable of preventing the occurrence of an early-stage overrun and smoothly executing a transfer operation of the storage medium by storing and holding an overrun of the last transfer of the storage medium; and feeding back the last overrun to the damping position when a next transfer operation of the storage medium is executed within a predetermined time interval, and changing the damping position thereof.

### DISCLOSURE OF THE INVENTION

The storage media housing device according to the present invention includes a housing means for housing storage media; a position detecting means for detecting a position of the housing means; a transfer means for transferring the housing means to a fixed position on command; a control means for outputting a damping start position of the transfer means corresponding to the previously stored desired position to the transfer means, as a transfer control signal when the housing means is transferred to a desired position; a compare means for comparing a detected position of the housing means detected by the position detecting means with the desired position at this time when the control means controlled the housing means; and a position changing means for changing the transfer control signal of the control means based on the compared result of the compare means and for changing the damping start position of the housing means.

According to the present invention, it achieves improved convergency to the target position, and increased reliability of the device by reflecting again an overrun occurred during transfer of the storage media to the housing position on the damping position during transfer to the housing position of the storage media.

### BRIEF DESCRIPTION OF THE DRAWINGS

FIG. 1 is a block diagram of a storage media housing device.

FIG. 2 is a general block diagram showing the first embodiment of the present invention.

FIG. 3 is a flowchart showing an operation of the first embodiment of the present invention.

FIG. 4 is a general block diagram showing the second embodiment of the present invention.

FIG. 5 is a flowchart showing an operation of the second embodiment of the present invention.

FIG. 6 is a general block diagram showing the third embodiment of the present invention.

FIG. 7 is a flowchart showing an operation of the third embodiment of the present invention.

### BEST MODE FOR CARRYING OUT THE INVENTION

Embodiments of the present invention will now be described with reference to the accompanying drawings in order to explain the present invention in more detail.

First Embodiment

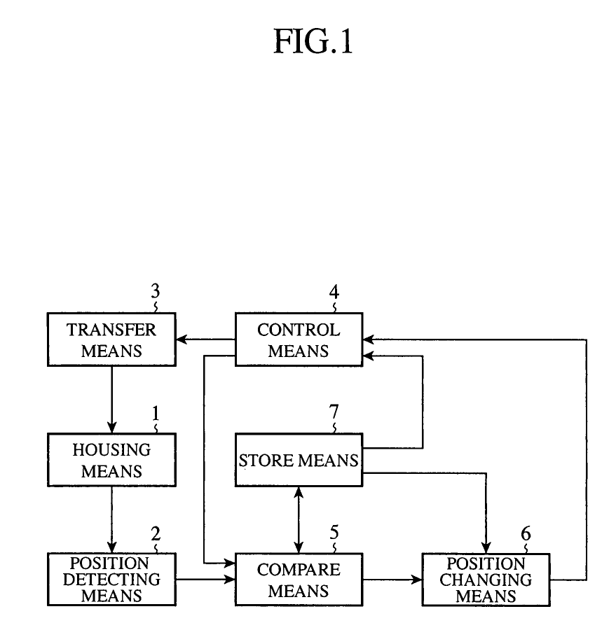

FIG. 1 is a block diagram of a storage media housing device according to the present invention.

Referring first to FIG. 1, a housing means 1 is for housing disks by means of a support member supporting the inside diameter of the disks, the housing means 1 being transferred to a desired position by a transfer means mentioned later.

A position detecting means 2 is for detecting a position of the housing means 1; the transfer means 3 is for transferring a bar-shaped member performing a screw operation by a rotating operation, the transfer means 3 is arranged to engage the housing means 1, and a going up and down movement of the housing means 1 being executed by the screw operation.

A control means 4 is for outputting, to the transfer means 3, a rotating direction and the amount of rotation of the screw operation in the form of a transfer control signal, as a damping start position, corresponding to a previously stored desired position such that the housing means 1 is transferred to the desired position; a compare means 5 is for comparing the desired position of the housing means based on the transfer control signal controlled by the control means 4 and a detected position of the housing means detected by the position detecting means 2; and a position changing means 6 is for changing the transfer control signal of the control means 4 based on the compared result of the compare means 5 and for changing the transfer position of the housing means 1.

Further, a store means 7 is for storing the compared result of the compare means 5; and the position changing means 6 is arranged to change the transfer control signal of the control means 4 based on the memory content of the store means 7 and change a transfer position of the housing means 1.

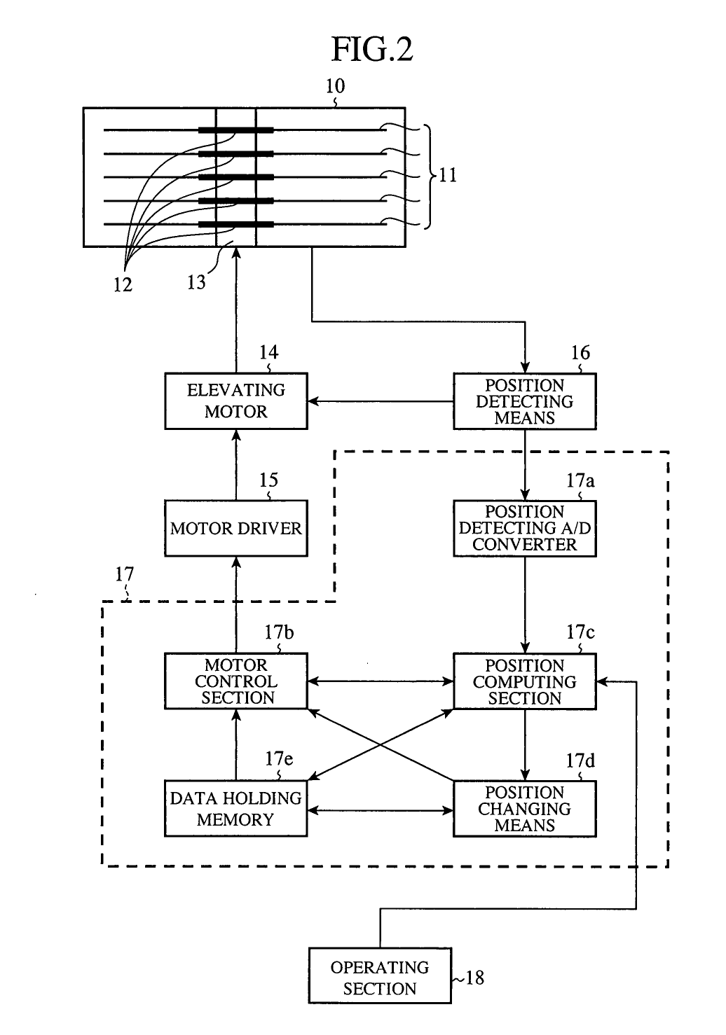

FIG. 2 shows a general block diagram of a specific embodiment of a device allowing an exchange of a plurality of media, serving as the storage media housing device.

Referring to FIG. 2, a reproducing device 10 is the storage media housing device, which can house optical disks such as CDs or DVDs, or storage media such as memory cards; media 11 is the storage media housed within the reproducing device 10, and the media 11 are explained as optical disks such as CDs or DVDs in the first embodiment.

Furthermore, a support member 12 is for supporting the inside diameter of the disks as the housing means 1 for housing the media 11; the bar-shaped member 13 is the transfer means 3 for transferring the disks supported by the support member 12 by transferring the support member 12 to the desired position (target position) by a screw operation. The reproducing device 10, acting as an elevating device, is composed of the support member 12 and the bar-shaped member 13.

An elevating motor 14 is for driving the bar-shaped member 13 to cause the support member 12 to go up and down; a motor driver 15 is for driving the elevating motor 14; a position detecting means 16 is for operating synchronously with a going up and down movement of the bar-shaped member 13 and converting the housing position at which the medium 11 is disposed into voltage to detect the housing position; and a microcomputer 17 is for controlling the whole device by a signal input from outside.

The microcomputer 17 is composed of a position detecting A/D converter 17a numerically converting voltage output from the position detecting means 16; a motor control section 17b controlling the elevating motor 14; a position operating section 17c, serving as a controlling means, computing the distance to the a destined position, with the damping start position of the bar-shaped member 13 as the desired position to which the housing means 1 is transferred from the present position thereof based on an output result of the position detecting A/D converter 17a, outputting a transfer control signal to the motor control section 17b controlling the elevating motor 14 included in the transfer means 3 so that the support means 12 is transferred to the desired position, and comparing the target position with the desired position of the support member 12 based on the transfer control signal, and the detected position of the support member 12 detected by the position detecting A/D converter 17a; a position changing means 17d for changing the transfer control signal of the motor control section 17b based on the compared result of the position computing section 17c, and for changing a position to which the support member 12 is transferred; and a data holding memory 17e storing and holding an overrun that is a difference between a position at which the medium 12 is actually stopped and the target position when the medium is transferred to the target position, and a damping distance that is a distance from the start of damping to the stop thereof.

Further, an operating section 18 is for selecting the desired support member 12, which outputs the desired support member 12 and the target position to the motor control section 17b and the position computing section 17c.

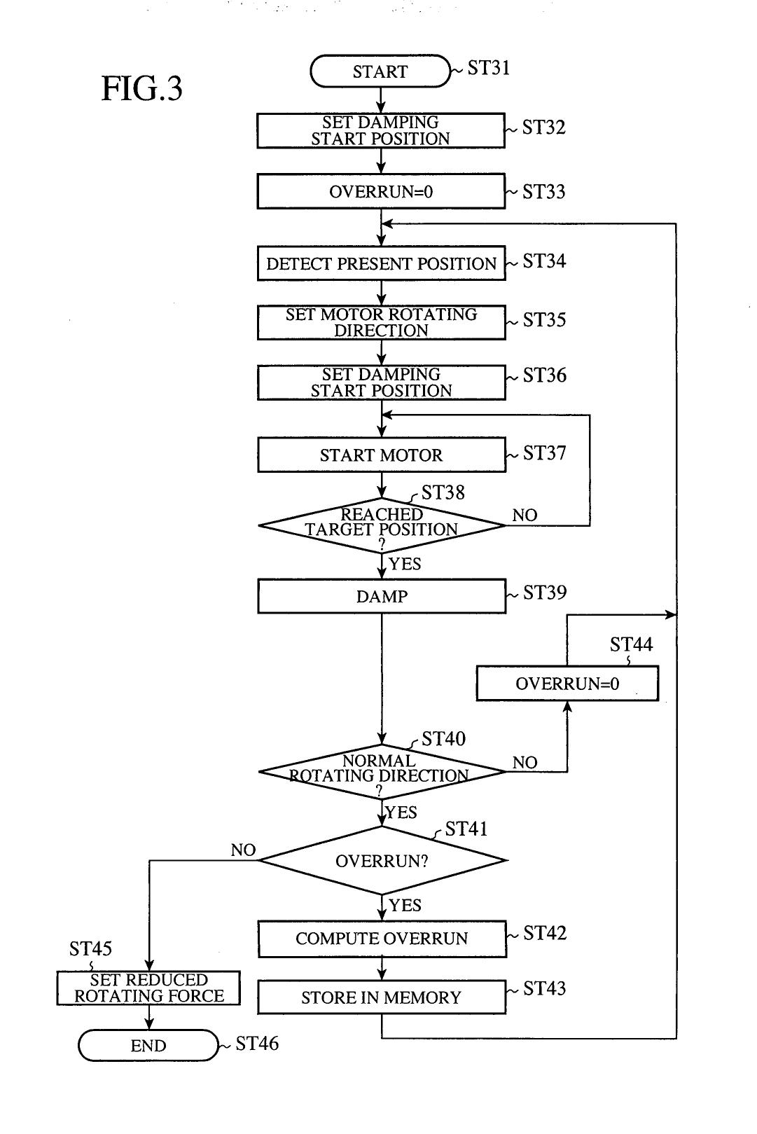

The operation of the first embodiment will now be described by referring to FIG. 2 and FIG. 3.

FIG. 3 is a flowchart showing an operation of the storage media housing device according to the present invention.

First, when an operation is carried out to exchange a medium from the operating section 18 (step 31), a damping start position is set in the position computing section 17c in order to transfer the support member 12 by the bar-shaped member 13 (step 32); and an initial value of the overrun stored and held in the data holding memory 17e is set to 0 (step 33).

Subsequently, the present position of the support member 12, which is a subject of detection, is detected by the position detecting means 16 and the position detecting A/D converter 17a (step 34); the position computing section 17c determines in which direction the elevating motor 14 rotates, i.e., in a normal rotating direction or a reverse rotating direction from the present position of the support member 12, detected in step 34 and the target position (step 35); the elevating motor 14 is started (step 37) after the damping start position is set based on the result of step 35 (step 36). Moreover, as described later, when an overrun is occurred, it is necessary to add the overrun to the damping start position in step 36. Therefore, the damping distance is a value obtained by adding the overrun to the damping distance used last time; however, the overrun, which is added to the damping start position in the first step 36, is set to 0 by an adding initial setting as described above, and therefore, the stored damping distance is used here as it is.

Then, the position computing section 17c judges whether the medium 12 reached the damping start section as the desired position by using an output from the position detecting A/D converter 17a (step 38). If the judgment shows in step 38 that the media 11 reached the damping start position, the motor control section 17b damps the elevating motor 14 so as to stop a going up and down movement of the support member 12 (step 39).

In the first embodiment, only when the motor control section 17b controls from a normal direction (shall be referred to as clockwise), a medium can stop at the desired position, and therefore, the medium cannot be damped at an accurate position from a reverse direction. When the medium is at a position where the medium has to be controlled from the reverse direction, the medium is once moved to a position where the medium can be damped from the normal direction, and then it is stopped at the desired position from the normal direction.

Since the medium can stop at the desired position only when the motor control section 17b controls from the normal direction (shall be referred to as clockwise), after step 39, a confirmation is done of a rotating direction of the motor of the elevating motor 14 determined in step 35 (step 40). If a rotating direction of the motor of the elevating motor 14 is the normal direction (shall be referred as clockwise), an overrun is computed by the position computing section 17c as a difference between the present position and the target position; and it is judged from the result whether the present position goes past the target position, i.e., whether an overrun is occurred (step 41). If the judgment shows in step 41 that the overrun is occurred, the position computing section 17c computes the overrun (step 42) ; and the overrun computed in step 42 is stored in the data holding memory 17f (step 43). After processing of step 43, the process returns to step 34 and the predetermined processing are repeated. When an overrun has been occurred, a new damping distance is obtained by adding the computed overrun to the damping distance used last time in step 36 where the damping distance position is set.

Meanwhile, if the judgment shows in step 38 that the support member 12 has not reached the target position, the process returns to step 37, and the processing are repeated.

Further, if the judgment shows in step 40 that a rotating direction of the motor of the elevating motor 14 is a reverse direction (counterclockwise), the medium cannot be damped at an accurate position, and even if the medium is fortunately damped, it does not stop at a predetermined position. Therefore, an overrun is set to 0 (step 44), the process returns to step 34, and the predetermined processing are repeated. A series of operations in step 40 where the rotating direction of the motor of the elevating motor 14 is a reverse direction (counterclockwise) are also carried out in like manner in the second and the third embodiments.

Otherwise, if the judgment shows in step 41 that no overrun has been occurred, the amount of rotation of the elevating means 14 is diminished, i.e., a rotating force thereof is slowed so as to reduce the amount of transfer of the bar-shaped member 13 and the support member 12; a going up and down movement of the support member 13 is slowly carried out (step 45). After confirmation of the stoppage of the support member 12 within the target range, the going up and down movement of the support member 12 is terminated (step 46).

The device thus arranged as stated above attains easy stoppage of the medium within the target range by adding the overrun to the damping position at the time of computation of the damping position in step 36.

It should be understood that while a detailed illustration of the elevator is omitted, in case the storage medium is an optical disk, the elevator is arranged such that the support member housing the disks is provided in the bar-shaped member, serving as the transfer means, to transfer in ascendable and descendable manner by supporting the inside diameter of the disks; or such that stockers, each of disks is mounted thereon, are provided, the disk is housed in the stocker by supporting each of the stockers, and the transfer means transfers these stockers in ascendable and descendable manner.

Second Embodiment

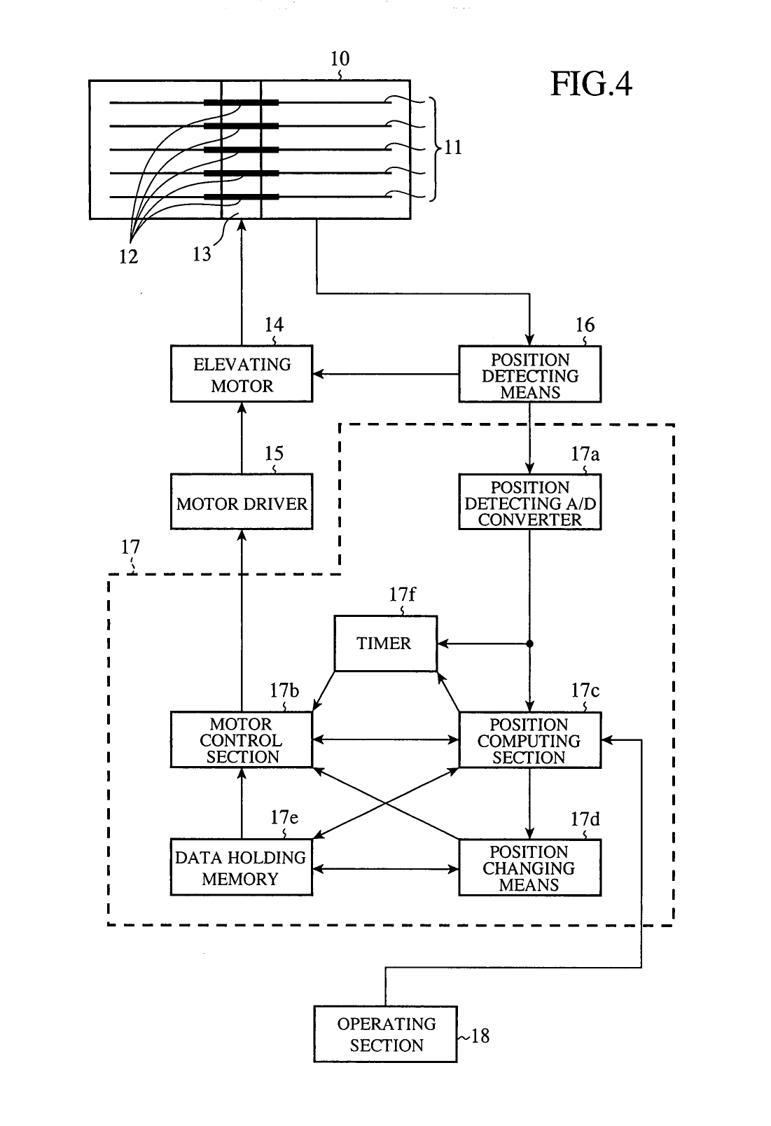

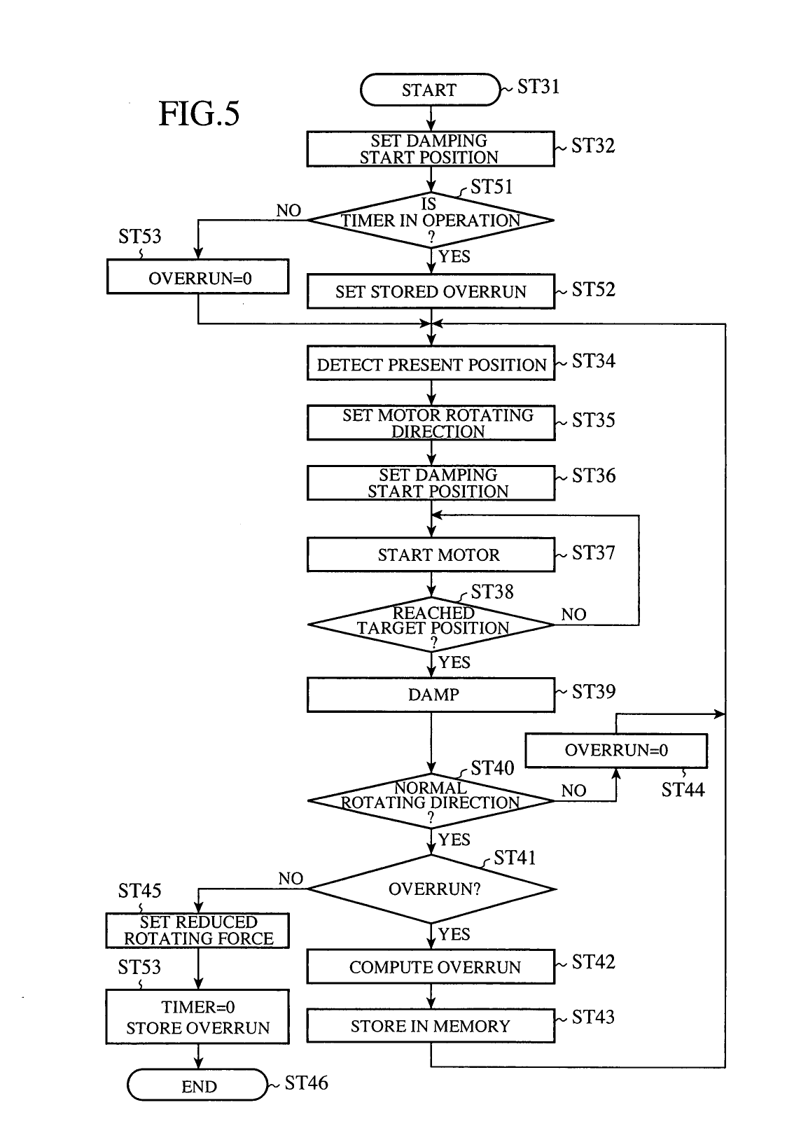

FIG. 4 is a general block diagram showing the whole configuration of another embodiment of the storage media housing device according to the second embodiment. FIG. 5 is a flowchart showing an operation of the second embodiment. The components having the same function as those of the above-described first embodiment are designated by the same reference numerals, and an explanation thereof is omitted for economy of space.

Referring to FIG. 4, a timer 17f is a timing means for measuring a predetermined time interval (e.g., one minute) after a going up and down movement of the support member 12. The purport of the second embodiment is in that in doing a going up and down movement of the support member 12, when the measured result of the timer 17f is within a predetermined time interval, the position changing means 17d changes a transfer control signal of the motor control section 17b based on the memory content of the data holding memory 17e to change the target position of the support member 12.

The operation of the second embodiment will now be described below by referring to FIG. 5.

First, when an operation to exchange the medium is performed from the operating section 18 (step 31), the damping start position corresponding to the desired position is set in the position computing section 17c in order to transfer the support member 12 by the bar-shaped member 13 (step 32); it is judged whether the timer 17f is started (step 51). If the judgment shows in step 51 that the timer 17f is in operation, the data obtained by adding the last overrun to the damping distance used last time, which is stored in the data holding memory 17e (step 52).

Subsequently, the present position of the support member 12, which is a subject of detection, is detected by the position detecting means 16 and the position detecting A/D converter 17a (step 34). The position computing section 17c determines in which direction the elevating motor 14 rotates, i.e., in a normal rotating direction or a reverse rotating direction from the present position of the support member 12 detected in step 34, and the damping start position (step 35); the elevating motor 14 is started (step 37) after the damping start position is set by the position computing section 17c using the new damping distance based on the result of step 35 (step 36).

After that, the position computing section 17c judges whether the medium 12 has reached the damping start position as the target position by using an output from the position detecting A/D converter 17a (step 38). If the judgment shows in step 38 that the medium 12 reached the damping start position, the motor control section 17b damps the elevating motor 14 so as to stop a going up and down movement of the support member 12 (step 39).

After step 39A, a confirmation is done of the rotating direction of the motor of the elevating motor 14 determined in step 35 (step 40). If the confirmation proved that the rotating direction of the motor of the elevating motor 14 is a normal direction (shall be considered as clockwise), an overrun is computed by the position computing section 17c as a difference between the present position and the damping start position, and it is judged from the result whether the present position goes past the damping start position, i.e., whether an overrun is occurred (step 41). If the judgment shows in step 41 that the overrun is occurred, the position computing section 17c computes the overrun (step 42); the overrun computed in step 42 is stored in the data holding memory 17f (step 43); the process returns to step 34, and the prescribed processing are repeated after processing of step 43, with the value obtained by adding the overrun to the damping distance used last time as the new damping distance.

Meanwhile, if the judgment shows in step 51 that the timer 17f is not started, an initial value of the overrun stored and held in the data holding memory 17e is set to 0 (step 53), the process proceeds to step 34, and the following processing are performed. Accordingly, the value of the overrun, which is added in the first step 36, is set to 0. When an overrun is occurred with the overrun setting to 0, the prescribed operations are repeated with the new overrun distance obtained by adding the overrun to the damping distance used last time as with the first embodiment.

Also, if the judgment shows in step 41 that no overrun has been occurred, the amount of rotation of the elevating means 14 is diminished, i.e., a rotating force thereof is weakened so as to reduce the amount of transfer of the bar-shaped member 13 and the support member 12; a going up and down movement of the support member 13 is slowly carried out (step 45). After processing of step 45, the overrun is stored, the timer 17f is initialized, and the timer 17f is started (step 54). The going up and down movement of the support member 12 is terminated (step 46) after confirmation of the stoppage of the support member 12 within the target range.

The second embodiment thus arranged as mentioned above permits easy stoppage of the media within the target range, thus realizing improved convergency to the target position and a shortened exchange time of the media by adding the overrun computed at the time of the last (just before) disk exchange operation and by determining the damping start position, as long as an elapsed time measured by the timer 17f from a point of time of completion of the last disk exchange operation is within a predetermined time interval.

Third Embodiment

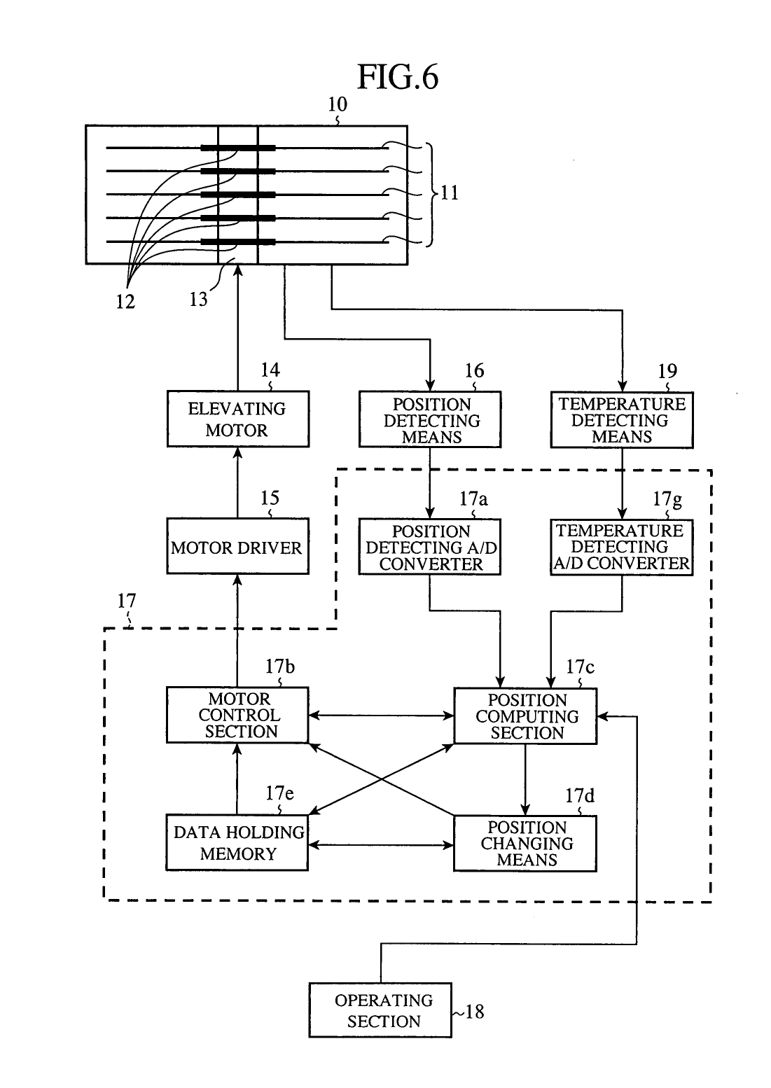

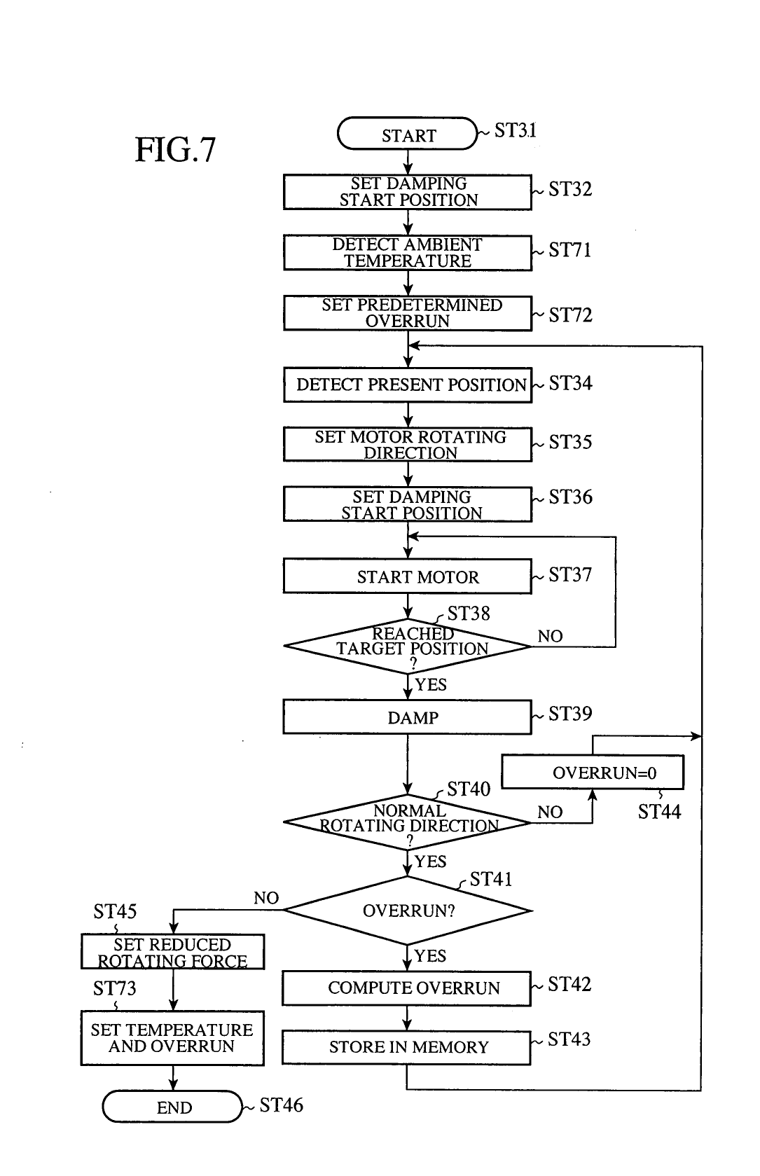

FIG. 6 is a general block diagram showing the whole configuration of another embodiment of the storage media housing device according to the third embodiment. FIG. 7 is a flow chart showing an operation of the third embodiment. The components having the same function as those of the above-described first embodiment are designated by the same reference numerals, and an explanation thereof is omitted for economy of space.

Referring to FIG. 6, reference numeral 19 denotes a temperature detecting means, composed of a thermistor or the equivalent, for measuring a temperature around the device; reference numeral 17g denotes a temperature detecting A/D converter provided within the microcomputer 17, numerically converting voltage detected by the temperature detecting means 19. An output of the temperature detecting A/D converter 17g is input in the position computing section 17c together with an output of the position detecting A/D converter 17a.

The position computing section 17c is for comparing an ambient temperature measured by the temperature detecting means 19 at the time of a going up and down movement of the support member 12 by the bar-shaped member 13 and the last temperature data stored in the data holding memory 17e, outputting an overrun corresponding to the ambient temperature to the position changing means 17d, changing a transfer control signal to the motor control section 17b, and changing the target position of the support member 12.

The operation of the third embodiment will next be described below by referring to FIG. 7.

First, when an operation to change the medium is performed from the operating section 18 (step 31); a damping start position is set in the position computing section 17c in order to transfer the support member 12 by the bar-shaped member 13 (step 32). The temperature detecting means 19 measures an ambient temperature of the device (step 71); and the predetermined damping distance, stored in the data holding memory 17e, corresponding to the temperature measured in step 71 is set in the motor control section (step 72).

After processing of step 72, the present position of the support member 12, which is a subject of detection, is detected by the position detecting means 16 and the position detecting A/D converter 17a (step 34); the position computing section 17c determines in which direction the elevating motor 14 rotates, i.e., in a normal rotating direction or a reverse rotating direction by the position computing section 17c from the present position of the support member 12 detected in step 34 and the damping start position (step 35). The elevating motor 14 is started (step 37) after the damping start position is set by the position operating section 17c using the damping distance based on the result of step 35.

Then, the position computing section 17c judges whether the medium 12 has reached the damping start position as the target position by using an output from the position detecting A/D converter 17a (step 38). If the judgment shows in step 38 that the medium 2 reached the damping start position, the motor control section 17b begins damping of the elevating motor 14 so as to stop the going up and down movement of the support member 12 (step 39).

After processing of step 39, a confirmation is done of the rotating direction of the motor of the elevating motor 14 determined in step 35 (step 40). If the rotating direction of the motor of the elevating motor 14 is a normal direction (shall be considered as clockwise), the overrun is computed by the position computing section 17c as a difference between the present position and the damping start position, and it is judged from the result whether the present position goes past the damping start position, i.e., whether an overrun has been occurred (step 41). If the judgment shows in step 41 that the overrun has been occurred, the position computing section 17c computes the overrun (step 42); the overrun computed in step 42 is stored in the data holding memory 17f (step 43), the process returns to step 34, and the prescribed processing are repeated after completion of step 43, with the value obtained by adding the overrun to the damping distance used last time as the new damping distance.

Otherwise, if the judgment shows in step 41 that no overrun has been occurred, the amount of rotation of the elevating means is diminished, i.e., a rotating force thereof is weakened so as to reduce the amount of transfer of the bar-shaped member and the support member 12; a going up and down movement of the support member 13 is slowly carried out (step 45). After processing of step 45, the damping distance and the ambient temperature data measured by the temperature detecting means are stored in the data holding memory 17e (step 73). The going up and down movement of the support member 12 is terminated (step 46) after completion of the stoppage of the support member within the target range.

The third embodiment thus arranged as mentioned above allows easy stoppage of the medium within the targeted range, thus realizing improved convergency to the damping start position and a shortened exchange time of the media using the overrun under the same condition by learning and storing the ambient temperature of the storage media housing device that is prone to produce an error in the transfer distance based on relationship to the overrun and by determining the damping position using the damping distance corresponding to temperature conditions at the time of an exchange operation of the disk.

Incidentally, while in the first to third embodiments, explanations are given for the disk exchanging device, needless to say, this technology may be applied to any device having a construction parallel to that of another invention.

Alternatively, whereas in the first to third embodiments, explanations are given as an arrangement that performs a going up and down movement and a transfer operation of the housing means, as a matter of course, the present invention is not limited to such going up and down movement, and may be similarly implemented even in a carrying direction of the media.

### INDUSTRIAL APPLICABILITY

As mentioned above, the storage media housing device according to the present invention is suitable, e.g., for a media reproducing device in a vehicle to smoothly execute a transfer operation of the storage media.

1. A storage media housing device comprising:
a housing means for housing storage media;
a position detecting means for detecting a position of the housing means;
a transfer means for transferring the housing means to a desired position on command;
a control means, when the housing means is transferred to a desired position, for outputting a damping start position of the transfer means corresponding to the previously stored desired position, as a transfer control signal, to the transfer means;
a compare means, when the control means controlled the housing means, for comparing a detected position of the housing means detected by the position detecting means with the desired position at this time; and
a position changing means for changing the transfer control signal of the control means based on the compared result of the compare means and for changing the damping start position of the housing means.

2. The storage media housing device according to claim 1, wherein a store means for storing the compared result of the compare means is provided, and the position changing means changes the transfer control signal of the control means based on the memory content of the store means and changes the damping start position of the housing means.

3. The storage media housing device according to claim 2, wherein a timing means, after transfer of the housing means, for measuring a predetermined time interval is provided, and at the time of transferring the housing means again, when the measured result of the timing means is within the predetermined time interval, the transfer control signal of the control means is changed based on the memory content of the store means to change the damping start position of the housing means.

4. The storage media housing device according to claim 2, wherein a temperature measuring means for measuring an ambient temperature is provided; when the housing means is transferred by the transfer means, the ambient temperature measured by the temperature measuring means and the compared result of the compare means are stored in the store means; and at the time of transferring the housing means again, the measured result measured by the temperature measuring means and the ambient temperature stored in the store means are compared, and when the comparison shows that a difference between both values is within a predetermined range, the transfer control signal to the control means is changed based on the compared result of the compare means stored in the store means to change the damping start position of the housing means.

5. The storage media housing device according to claim 1, wherein the transfer means transfers the housing means by going up and down movement.

6. The storage media housing device according to claim 1, wherein the transfer means is provided with a motor rotating when the housing means is transferred; and the compared result obtained by the compare means by comparing the desired position of the housing means and the detected position of the housing means detected by the position detecting means shows that a difference therebetween is within a predetermined range, the transfer control means outputs a transfer control signal to the control means so as to weaken a rotating force of the motor, and to thereby transfer the housing means to the desired position.
